(19) United States
(12) Patent Application Publication
(10) Pub. No.: US 2016/0069926 A1
(43) Pub. Date: Mar. 10, 2016

(54) ACCELERATION SENSOR AND METHOD OF MANUFACTURING THE SAME

(71) Applicant: Samsung Electro-Mechanics Co., ltd.,, Suwon-si (KR)

(72) Inventors: Tae Yoon KIM, Suwon-si (KR); Seung Hoon HAN, Suwon-si (KR); Chang Hyun LIM, Suwon-si (KR)

(73) Assignee: SAMSUNG ELECTRO-MECHANICS CO., LTD.,, Suwon-si (KR)

(21) Appl. No.: 14/698,329

(22) Filed: Apr. 28, 2015

(30) Foreign Application Priority Data
Sep. 4, 2014 (KR) 10-2014-0117868

(51) Int. Cl. G01P 15/12; G01L 1/16

(52) U.S. Cl. CPC G01P 15/123; G01L 1/162

(57) ABSTRACT

There is provided an acceleration sensor in which outer surfaces of a plurality of beams in which piezo-resistive elements are provided and upper portions of a mass body and a support body connected to the plurality of beams may be enclosed by a protective layer to prevent electrical disturbances from being transferred from an external environment to the piezo-resistive elements.

### CROSS-REFERENCE TO RELATED APPLICATION

This application claims the priority and benefit of Korean Patent Application No. 10-2014-0117868 filed on Sep. 4, 2014, with the Korean Intellectual Property Office, the disclosure of which is incorporated herein by reference.

### BACKGROUND

The present disclosure relates to an acceleration sensor and a method of manufacturing the same.

Generally, acceleration sensors have a variety of applications and are commonly used in automobiles, airplanes, mobile communications terminals, toys, and the like. Recently, as small, light acceleration sensors have come to be easily manufactured using micro-electro-mechanical systems (MEMS) technology, the range of applications of acceleration sensors has increased.

In addition, in accordance with the continuous development of sensor functions, a multi-axis sensor capable of measuring acceleration on two or more axes using a single sensor has also been developed.

Generally, as the acceleration sensor, converting movement of a mass body into an electrical signal, there is provided a piezo-resistive acceleration sensor detecting the movement of the mass body from a change in resistance of a piezo-resistive element disposed in a flexible part.

However, the piezo-resistive acceleration sensor may have a problem, in that resistance values caused by electrical disturbances being transferred to the piezo-resistive body may be changed, due to moisture or ions absorbed from an external environment.

### SUMMARY

An aspect of the present disclosure may provide an acceleration sensor capable of preventing electrical disturbances from being transferred from an external environment to a piezo-resistive element, and a method of manufacturing the same.

In an acceleration sensor according to an aspect of the present disclosure, outer surfaces of a plurality of beams in which piezo-resistive elements are provided and upper portions of a mass body and a support body connected to the plurality of beams may be enclosed by a protective layer to prevent electrical disturbances from being transferred from an external environment to the piezo-resistive elements.

In a method of manufacturing an acceleration sensor according to another aspect of the present disclosure, first and second substrates may be stacked with a first insulating layer interposed therebetween, the second substrate may be etched to form through-holes, and a second insulating layer may be formed in the through-hole. In addition, piezo-resistive elements may be formed on an upper surface of the second substrate, and a third insulating layer may be formed on the upper surface of the second substrate. Then, the second substrate may be etched to form the plurality of beams in which the piezo-resistive elements are provided, an upper portion of the mass body, and an upper portion of the support body, thereby allowing the plurality of beams, the upper portion of the mass body, and the upper portion of the support body to be enclosed by first to third insulating layers.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a plan view of an acceleration sensor according to an exemplary embodiment of the present disclosure;

FIG. 2 is a cross-sectional view taken along line A-B of FIG. 1;

FIG. 3 is a cross-sectional view taken along line C-D of FIG. 1;

FIGS. 4 through 10 are views illustrating a method of manufacturing an acceleration sensor according to an exemplary embodiment of the present disclosure;

FIG. 11 is a plan view of an acceleration sensor according to another exemplary embodiment of the present disclosure; and

FIG. 12 is a cross-sectional view taken along line E-F of FIG. 11.

### DETAILED DESCRIPTION

Exemplary embodiments of the present disclosure will now be described in detail with reference to the accompanying drawings.

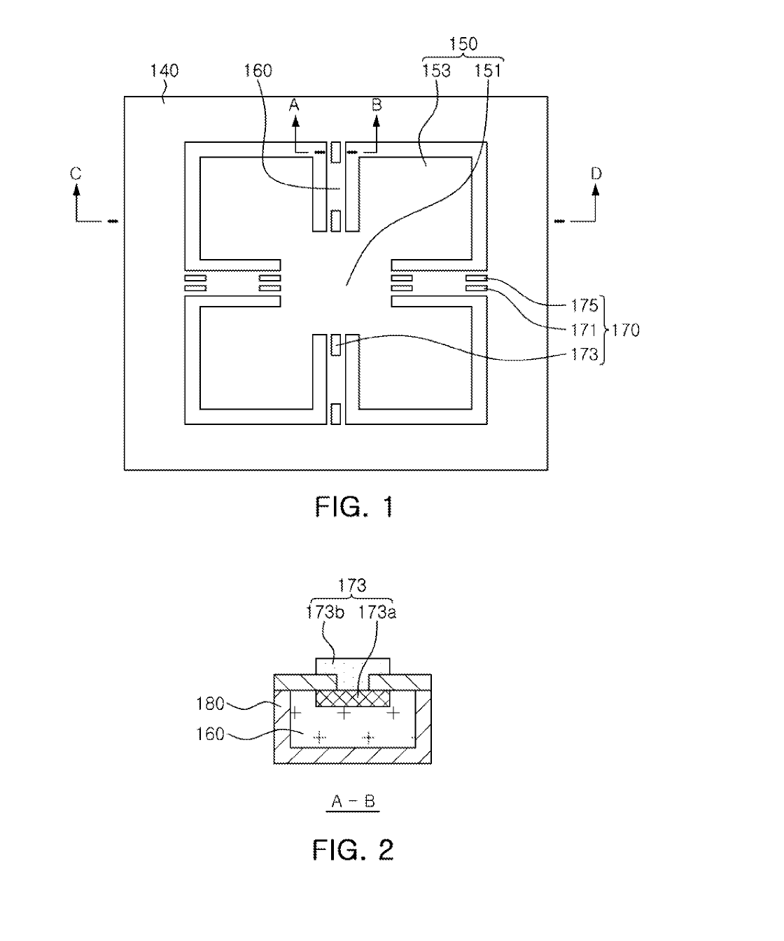

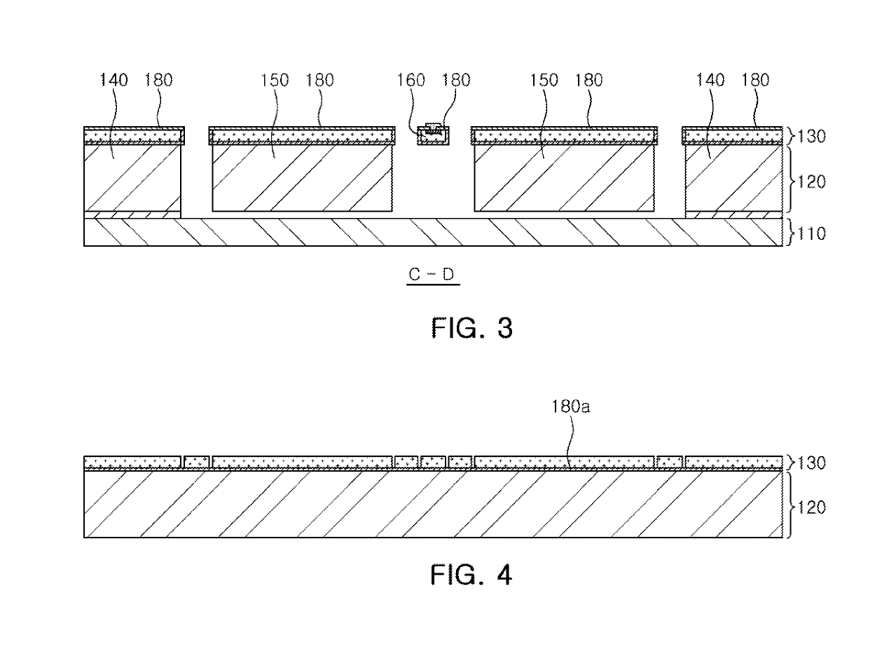

FIG. 1 is a plan view of an acceleration sensor according to an exemplary embodiment of the present disclosure; FIG. 2 is a cross-sectional view taken along line A-B of FIG. 1; and FIG. 3 is a cross-sectional view taken along line C-D of FIG. 1.

Referring to FIGS. 1 through 3, the acceleration sensor according to an exemplary embodiment of the present disclosure may include a mass body 150, a support body 140, a plurality of beams 160, a plurality of sensing bodies 170, and a protective layer 180.

The support body 140 may have a hollow portion to enclose the mass body 150. Therefore, the support body 140 may have inner walls to form the hollow portion, and may provide a space in which the mass body 150 may be displaced.

The mass body 150 may be disposed in a space formed in a central portion of the support body 140, and may be disposed to be spaced apart from the support body 140.

The mass body 150 may be connected to the support body 140 by the plurality of beams 160.

For example, each of the plurality of beams 160 may have one end connected to the support body 140 and the other end connected to the mass body 150. Therefore, the mass body 150 may be supported in a state in which it is suspended by the plurality of beams 160.

The mass body 150 may include a central portion 151 and a peripheral portion 153. The central portion 152 may be a portion to which the other ends of the plurality of beams 160 are connected, and the peripheral portion 153 may be a portion protruding from the central portion 151 toward the support body 140 and be disposed to be spaced apart from the plurality of beams 160.

The plurality of beams 160 may connect the support body 140 and the mass body 150 to each other and elastically support the mass body 150.

The plurality of beams 160 may support the central portion 151 of the mass body 150 in four directions and may be disposed symmetrically with respect to each other, based on the central portion 151.

The plurality of sensing bodies 170 may be formed in each of the plurality of beams 160 and have resistance values changed by displacement of the mass body 150.

For example, the mass body 150 may be displaced by a moment generated by external force, and the plurality of sensing bodies 170 formed in the plurality of beams 160 may have resistance values changed by the displacement of the mass body 150.

To this end, each of the plurality of sensing bodies 170 may be formed of a piezo-resistive element including a piezo-resistive body and an electrode formed on the piezo-resistive body.

For example, each of the plurality of sensing bodies 170 may include an X axis piezo-resistive element 171, a Y axis piezo-resistive element 173, and a Z axis piezo-resistive element 175.

Here, referring to FIG. 2, the protective layer 180 may be formed on each of outer surfaces of the plurality of beams 160. The protective layer 180 may be formed to enclose the outer surfaces of the plurality of beams 160 to protect the plurality of sensing bodies 170 (173 in FIG. 2) from an external environment.

In a case in which moisture or ions are absorbed from the external environment, leading to electrical disturbances in piezo-resistive bodies 173a provided in the plurality of sensing bodies 170 (173 in FIG. 2), resistance values of the plurality of sensing bodies 170 (173 in FIG. 2) may be changed over time. Therefore, the piezo-resistive bodies 173a need to be shielded from the external environment.

Therefore, in the acceleration sensor according to an exemplary embodiment of the present disclosure, the outer surfaces of the plurality of beams 160 may be enclosed with the protective layer 180 to allow the piezo-resistive bodies 173a to be shielded from the external environment.

The protective layer 180 may be formed to continuously enclose an upper surface, a lower surface, and side surfaces of each of the plurality of beams 160.

Therefore, the piezo-resistive bodies 173a may be enclosed in a state in which they are sealed from the external environment by the plurality of beams 160, the protective layer 180, and the electrodes 173b.

In addition, since the mass body 150 and the support body 140 are connected to each other by the plurality of beams 160 in which the plurality of sensing bodies 170 are formed, there is a risk that electrical disturbances may be transferred to the plurality of sensing bodies 170 through the mass body 150 and the support body 140.

Therefore, the protective layer 180 may also be formed on the upper portion of the mass body 150 and the support body 140 to allow the mass body 150 and the support body 140 to be shielded from the external environment.

Meanwhile, referring to FIG. 3, the mass body 150 and the support body 140 may be formed of a plurality of layers.

For example, in the present exemplary embodiment, two substrates 120 and 130 may be stacked to form the mass body 150 and the support body 140.

Here, the uppermost layers (130 in FIG. 3) of the mass body 150 and the support body 140 may be connected to each other by the plurality of beams 160.

Each of the uppermost layers (130 in FIG. 3) of the mass body 150 and the support body 140 may be enclosed by the protective layer 180 and be shielded from the external environment by the protective layer 180.

That is, in the acceleration sensor according to the exemplary embodiment of the present disclosure, each of the uppermost layer of the mass body 150, the uppermost layer of the support body 140, and the outer surfaces of the plurality of beams 160 may be enclosed by the protective layer 180.

Therefore, the transfer of electrical disturbances from the external environment to the plurality of sensing bodies 170 provided in the plurality of beams 160 may be prevented.

FIGS. 4 through 10 are views illustrating a method of manufacturing an acceleration sensor according to an exemplary embodiment of the present disclosure.

The method of manufacturing an acceleration sensor according to the exemplary embodiment of the present disclosure will be described with reference to FIGS. 4 through 10.

First, referring to FIG. 4, a first insulating layer 180a may be formed on an upper surface of a first substrate 120, and a second substrate 130 may be stacked on the first insulating layer 180a. That is, the first and second substrates 120 and 130 may be stacked with the first insulating layer 180a interposed therebetween.

Here, the first insulating layer 180a may serve as an etching stop layer and serve to protect the first substrate 120 from an etching process.

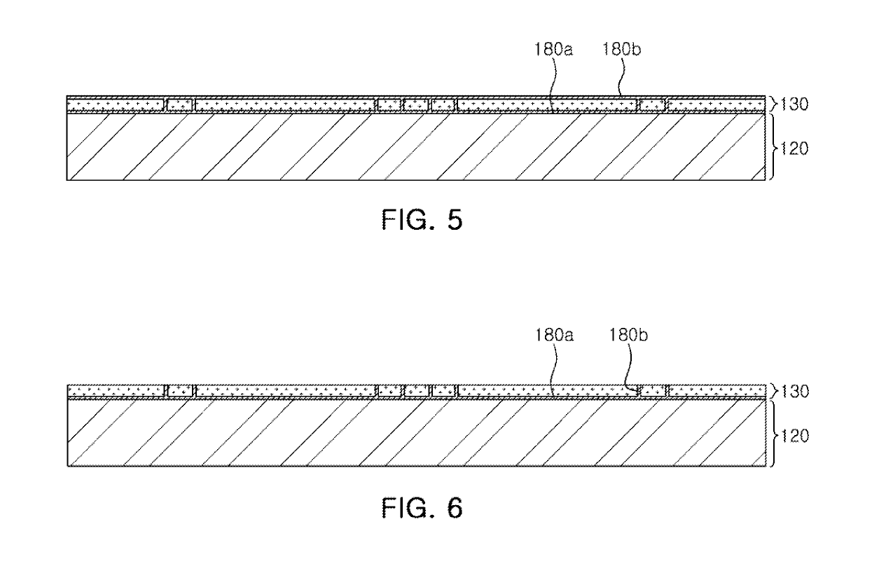

Referring to FIGS. 4 and 5, a plurality of through-holes may be formed in the second substrate 130 through the etching process, and a second insulating layer 180b may be formed on an upper surface of the second substrate 130 and in the through-holes.

Here, the second insulating layer 180b formed in the through-holes may be formed to contact the first insulating layer 180a.

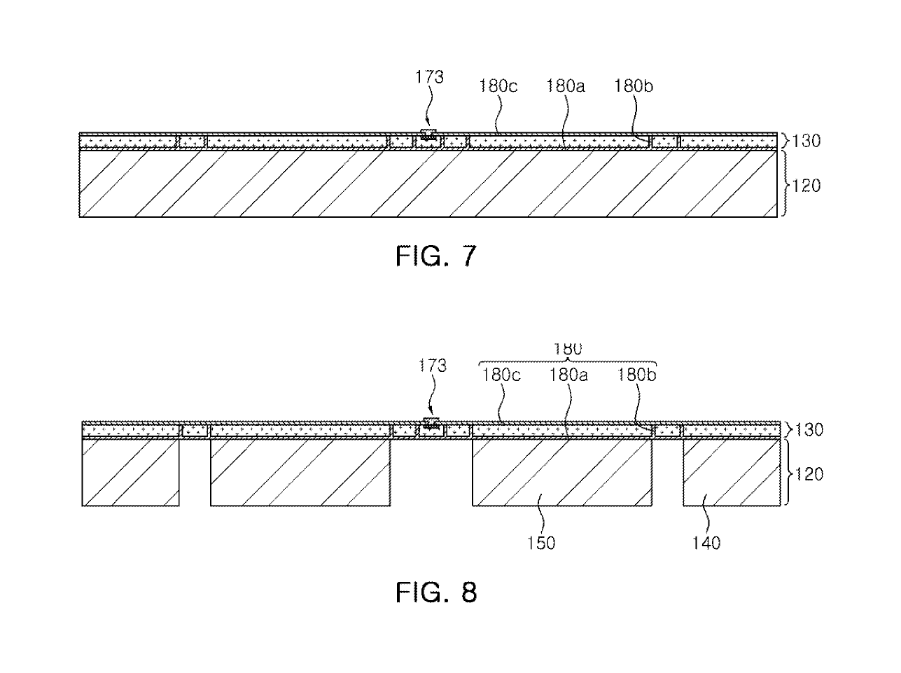

Next, referring to FIGS. 6 and 7, the second insulating layer 180b formed on the upper surface of the second substrate 130 may be removed, and a plurality of sensing bodies 170 (173 in FIG. 7) may be formed in predetermined positions on the second substrate 130.

Portions of the second substrate 130 on which the plurality of sensing bodies 170 (173 in FIG. 7) are formed may form the plurality of beams 160 in a subsequent etching process.

Next, a third insulating layer 180c may be formed on an upper surface of the second substrate 130 so that the piezo-resistive bodies provided in the plurality of sensing bodies 170 (173 in FIG. 7) are sealed from the external environment.

Here, the third insulating layer 180c may be formed to contact the second insulating layer 180b provided in the through-holes of the second substrate 130.

Therefore, the second substrate 130 may be enclosed by the first insulating layer 180a, the second insulating layer 180b, and the third insulating layer 180c.

Next, referring to FIG. 8, portions of the first substrate 120 may be removed to form lower portions of the support body 140 and the mass body 150.

The portions removed from the first substrate 120 may correspond to regions in which the through-holes are formed in the second substrate 130.

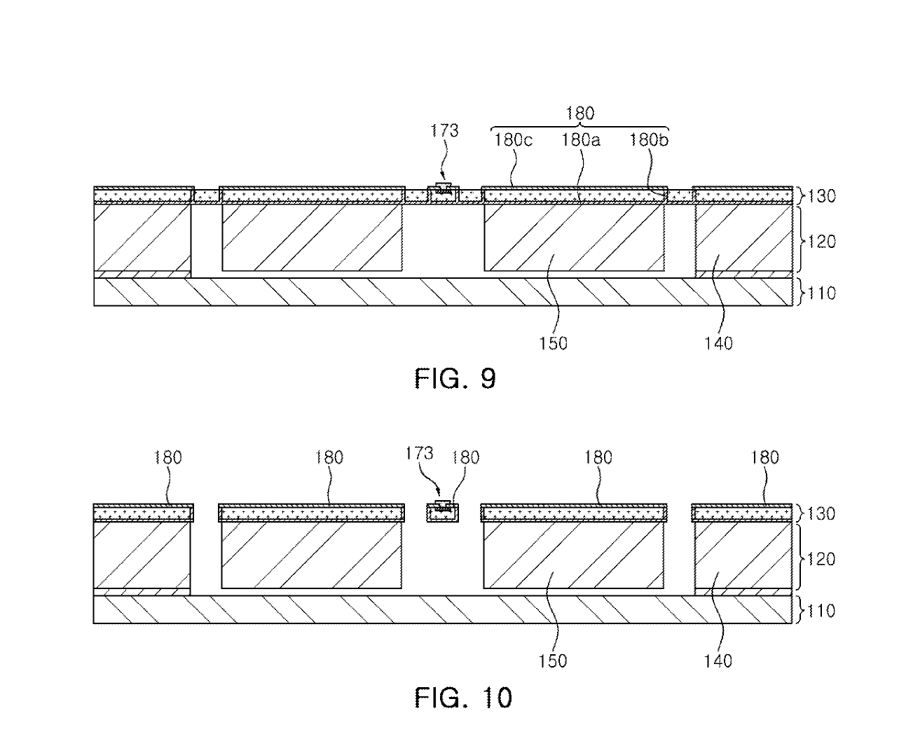

Next, referring to FIG. 9, a third substrate 110 may be coupled to the support body 140 so that the mass body 150 is suspended. The support body 140 may be bonded to the third substrate 110.

Next, referring to FIG. 10, portions of the second substrate 130 may be removed to form upper portions of the support body 140 and the mass body 150 and form the plurality of beams 160 connecting the upper portion of the support body 140 and the upper portion of the mass body 150 to each other.

The portions removed from the second substrate 130 may correspond to the portions partially removed from the first substrate 120.

As described above, the second substrate 130 forming the upper portions of the support body 140 and the mass body 150 and the plurality of beams 160 may be enclosed by the first to third insulating layers 180a to 180c to shield the piezo-resistive bodies provided in the plurality of sensing bodies 170 (173 in FIG. 10) from electrical disturbances transferred from the external environment.

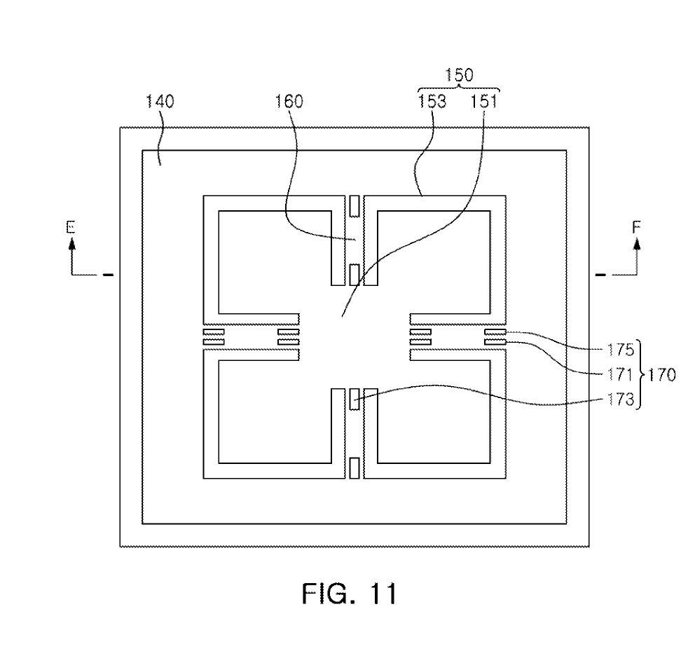

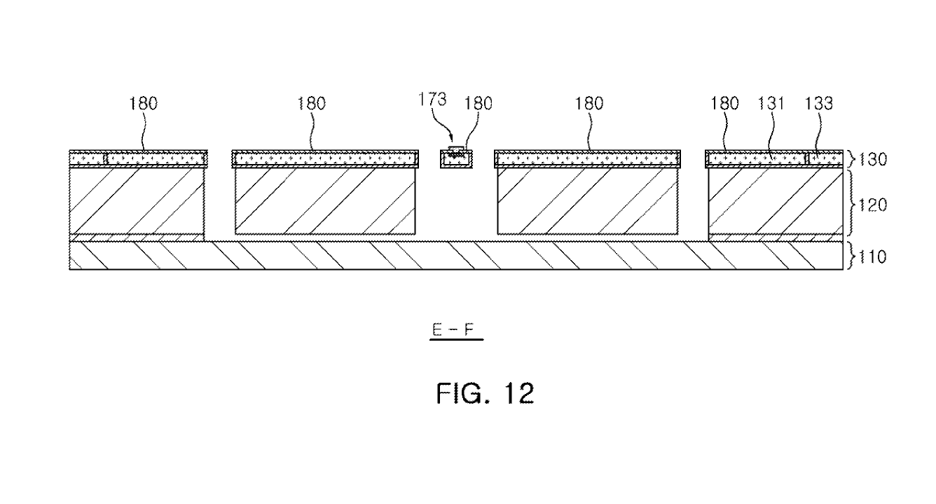

FIG. 11 is a plan view of an acceleration sensor according to another exemplary embodiment of the present disclosure; and FIG. 12 is a cross-sectional view taken along line E-F of FIG. 11.

Referring to FIGS. 11 and 12, in the acceleration sensor according to another exemplary embodiment of the present disclosure, an upper surface, a lower surface, and side surfaces of a partial region of the uppermost layer of the support body 140 may be enclosed by the protective layer 180.

Referring to FIG. 12, since a distal end of the acceleration sensor forms a surface cut in a wafer, it is difficult for the distal end of the acceleration sensor to be protected by the protective layer 180. However, in the acceleration sensor according to another exemplary embodiment of the present disclosure, the upper surface, the lower surface, and the side surfaces of the partial region of the uppermost layer of the support body 140 may be continuously enclosed by the protective layer 180.

Therefore, in the acceleration sensor according to another exemplary embodiment of the present disclosure, since the protective layer 180 may be formed on an outer side region of the acceleration sensor including components configuring the acceleration sensor, electrical disturbances from the external environment may be more effectively shielded.

Referring to the method of manufacturing an acceleration sensor according to the exemplary embodiment of the present disclosure described above, the acceleration sensor according to another exemplary embodiment of the present disclosure may be implemented by forming the through-holes also in the outer side regions of the acceleration sensor when forming the through-holes in the second substrate 130 and forming the second insulating layer 180b in the through-holes formed in the outer side region of the acceleration sensor.

Therefore, the outer side region of the acceleration sensor may also be shielded without performing an additional process.

As set forth above, in the acceleration sensor and the method of manufacturing the same according to the exemplary embodiment of the present disclosure, the transfer of electrical disturbances from the external environment to the piezo-resistive element may be prevented.

While exemplary embodiments have been shown and described above, it will be apparent to those skilled in the art that modifications and variations could be made without departing from the scope of the present invention as defined by the appended claims.

What is claimed is:

1. An acceleration sensor comprising:
a mass body;
a support body enclosing surrounding of the mass body;
a plurality of beams connecting the mass body and the support body to each other and elastically supporting the mass body;
a plurality of sensing bodies disposed in the plurality of beams and sensing deformation of the plurality of beams; and
a protective layer enclosing each of outer surfaces of the plurality of beams.

2. The acceleration sensor of claim 1, wherein each of the plurality of sensing bodies is formed of a piezo-resistive element including a piezo-resistive body and an electrode formed on the piezo-resistive body.

3. The acceleration sensor of claim 2, wherein the piezo-resistive body is enclosed by the plurality of beams, the protective layer, and the electrode.

4. The acceleration sensor of claim 3, wherein the piezo-resistive body is sealed from the outside.

5. The acceleration sensor of claim 1, wherein the protective layer continuously encloses upper surfaces, lower surfaces, and side surfaces of the plurality of beams.

6. The acceleration sensor of claim 1, wherein the protective layer covers an upper portion of the support body and an upper portion of the mass body.

7. An acceleration sensor comprising:
a support body including a plurality of layers;
a mass body including a plurality of layers, enclosed by the support body, and disposed to be spaced apart from the support body;
a plurality of beams connecting an uppermost layer of the support body and an uppermost layer of the mass body to each other;
a plurality of sensing bodies disposed in the plurality of beams and sensing deformation of the plurality of beams; and
a protective layer enclosing each of the uppermost layer of the support body, the uppermost layer of the mass body, and outer surfaces of the plurality of beams.

8. The acceleration sensor of claim 7, wherein each of the plurality of sensing bodies is formed of a piezo-resistive element including a piezo-resistive body and an electrode formed on the piezo-resistive body.

9. The acceleration sensor of claim 8, wherein the piezo-resistive body is shielded from the external environment by being enclosed by the plurality of beams, the protective layer, and the electrode.

10. The acceleration sensor of claim 7, wherein the protective layer continuously encloses the uppermost layer of the mass body and upper surfaces, lower surfaces, and side surfaces of the plurality of beams.

11. The acceleration sensor of claim 10, wherein the protective layer continuously encloses an upper surface, a lower surface, and side surfaces of a partial region of the uppermost layer of the support body.

12. A method of manufacturing an acceleration sensor, comprising:
sequentially stacking a first substrate, a first insulating layer, and a second substrate;
forming a plurality of through-holes in the second substrate;
forming a second insulating layer on an upper surface of the second substrate and in the through-holes;
removing the second insulating layer formed on the upper surface of the second substrate;
forming a plurality of sensing bodies on the second substrate and forming a third insulating layer on the upper surface of the second substrate;
removing portions of the first substrate to form a support body and a mass body;
coupling a third substrate to the support body so that the mass body is suspended; and
removing portions of the second substrate to form a plurality of beams connecting the support body and the mass body to each other.
